(19) United States
(12) Patent Application Publication
(10) Pub. No.: US 2025/0321161 A1
(43) Pub. Date: Oct. 16, 2025

(54) Computer-Implemented Method for Quantifying the Relevance of Measured Values in Time Series

(71) Applicant: Robert Bosch GmbH, Stuttgart (DE)

(72) Inventors: Eric Sebastian Schmidt, Moensheim (DE); Johannes Haug, Rottenburg (DE); Stefan Patrick Lindt, Ettlingen (DE)

(21) Appl. No.: 19/169,561

(22) Filed: Apr. 3, 2025

(30) Foreign Application Priority Data
Apr. 10, 2024 (DE) 10 2024 203 263.8

(51) Int. Cl. G01M 99/00

(52) U.S. Cl. CPC G01M 99/00

(57) ABSTRACT

A computer-implemented method for quantifying the relevance of measured values in time series includes (i) providing a measured time series, wherein the measured time series comprises a temporally ordered sequence of measured values, wherein the measured values have been captured as process parameters of an industrial process, (ii) providing a reference time series, (iii) determining residual values for the measured time series by comparing the measured time series to the reference time series, and (iv) determining a relevance value for each measured value of the measured time series from the residual values.

This application claims priority under 35 U.S.C. § 119 to patent application no. DE 10 2024 203 263.8, filed on Apr. 10, 2024 in Germany, the disclosure of which is incorporated herein by reference in its entirety.

The disclosure relates to the field of monitoring and analyzing industrial processes, in particular the associated data processing.

### BACKGROUND

The monitoring and analysis of industrial processes face an increasing challenge with respect to the management of large volumes of data. This abundance of data results from the implementation of sensors and IoT devices in various areas of industry. While these technologies help streamline processes and predict failures, they also present a complex problem.

Industrial plants and machines produce an enormous amount of data in real time. This data comprises parameters such as temperature, pressure, flow rates, accelerations due to movement or vibrations, and much more. Just capturing and storing this data can be challenging, especially when it occurs in large quantities and at high frequencies.

Furthermore, this data often needs to be analyzed in real time in order to identify potential problems or anomalies. This requires advanced analysis methods such as machine learning and artificial intelligence. Processing such large amounts of data, however, also requires significant computing resources and can result in delays that impair the ability to perform monitoring and control in real-time. Depending on a detected anomaly, the corresponding production processes can be intervened in or controlled, for example, the corresponding product can be discarded or marked as abnormal, or production can be stopped.

To reduce the amount of data in industrial process monitoring and analysis, various methods are used in order to extract relevant information and minimize unnecessary data. One of the best-known methods is data aggregation. In this process, raw data is summarized so as to reduce the number of data sets to be stored. This aggregation can be, for example, time-based by summarizing data over specific time intervals, or space-based by combining data from a plurality of sensors or sources into a single data set.

Another method is the reduction of sampling or down-sampling. In this process, data points are selected at a specific frequency in order to reduce the amount of data while maintaining important information. This can be particularly useful when the data is collected at a higher frequency than is required for analysis. However, it is difficult to distinguish between important and unimportant information.

Additionally, in data analysis, techniques such as feature extraction are often employed in order to extract and store or analyze only relevant information from the raw data. This process identifies and extracts certain features or characteristics of the data that are of interest for analysis and monitoring. This allows for a reduction in the amount of data, wherein however important information can be lost.

The disclosure thus addresses the problem of proposing a method for reducing the amount of data during monitoring and/or analysis of industrial processes without losing important information.

The problem is solved according to the disclosure by the subject-matter set forth below.

### SUMMARY

According to a first aspect of the disclosure, this problem is solved by a computer-implemented method for quantifying the relevance of measured values in time series, wherein the method comprises the following steps:
providing a measured time series, wherein the measured time series comprises a temporally ordered sequence of measured values, wherein the measured values have been captured as process parameters of an industrial process;
providing a reference time series;
determining residual values for the measured time series by comparing the measured time series to the reference time series; and
determining a relevance value for each measured value of the measured time series from the residual values.

An industrial process can be any commercially applicable process that uses at least one machine. In the context of this disclosure, a system refers to a combination of at least one machine, preferably a plurality of machines. Machines can perform all kinds of industrial processes. Industrial processes include, but are not limited to: conveying, cutting, drilling, milling, grinding, punching, casting and injection molding, assembling, welding, painting, packaging, positioning, etc.

The measured values during monitoring or analysis of an industrial process can therefore be any physical parameters that can be captured from the industrial process. These include, for example, the temperature of workpieces or machines and machine parts, the pressure within hydraulic or pneumatic systems, the movement speed of moving machine parts, the voltage or current in electronic components, etc.

The reference time series represents an ideal or average process flow, whereas the measured time series represents the actual process, which may be executed in real-time. The reference time series and the measured time series therefore relate to the same process parameter and have the same temporal division.

The measured values or data points of the time series can be captured, for example, in the microsecond range, millisecond range, or second range. Longer intervals are also generally possible, although these are rarely monitored in such an automated manner and with the problem of data volume.

The measured time series is compared to the reference time series in order to identify the differences. This difference shows where the measured time series deviates from the reference time series. For the monitored process, these deviations are relevant because differences from the standard in industrial processes often indicate errors in the process. The deviation is recorded as a residual value for each measured value.

For each measured value of the measured time series, a relevance value is determined from the residual value, generating a vector for the entire measured time series that indicates the relevance of each individual measured value for monitoring or analyzing the industrial process. A relevance map can therefore be generated for the entire process, which can be used for monitoring and analysis in order to reduce processing effort.

The measured time series can be entirely or partially below or above the reference time series. Both deviations increase the relevance value. Therefore, the absolute value of the residual value is preferably used in determining the relevance value.

Preferably, the determination of the relevance values for the measured values can be done during the capture of the measured time series, so that the relevance value can be used immediately during real-time monitoring of the industrial process.

In the manner described above, relevance values for the measured values of a plurality of measured time series can be determined. For example, a reference time series can be used for an entire series of industrial processes. If the reference time series does not change, this method can also detect gradual changes that could not be identified from individual time series or even in comparison with a few time series.

The relevance values indicate which measured values are particularly interesting for monitoring or analysis by reflecting the deviation of the measured values from the target or normal state. For non-critical sub-processes in which no changes usually occur from one execution to another, the relevance value is zero or almost zero, because these sub-processes hardly differ from the reference.

For example, the industrial process can be a drilling process in which the force on the drill head is monitored. The industrial process begins with positioning the drill head on the workpiece. Until the drill head is positioned, no force effectively acts on the drill head. That is to say, the measured force does not differ from the reference force, or only within the range of the measurement accuracy of the corresponding sensor. The relevance value is therefore very small. When the drill head begins drilling, a force also acts. For example, the force pattern during drilling can differ from a reference bore when irregularities occur in the workpiece, such as when the material is brittle or the workpiece is not correctly positioned for the process, etc. If the measured force deviates from the reference force, the relevance value for these measurements increases. During monitoring, a machine could then directly initiate countermeasures, for example, to correct or stop the process.

Regardless of how the measured time series is further processed, the processing of the time series can be limited to the measurements of the measured time series that have a particularly high relevance value. This reduces the data to be examined to a relevant minimum, conserving computing resources and thus simplifying the entire processing. For example, the amount of measurements marked as relevant can be set via a threshold value. The disclosure thus solves the problem in question.

In one embodiment, the residual values are determined from the difference between the measured time series and the reference time series.

Calculating the difference between the measured time series and the reference time series is a simple way to determine a residual value. For example, the monitoring system can have stored the reference time series in a work memory. When capturing each measurement, the difference compared to the corresponding value in the reference time series can be directly calculated and the result can be stored. Advantageously, this realizes a particularly simple form of the disclosure.

In one embodiment, the determination of the residual values comprises:
determining spline coefficients for the reference time series;
determining the spline coefficients for the measured time series;
determining the difference or differences between the spline coefficients of the reference time series and the measured time series, wherein the residual values are determined from the difference or differences of the spline coefficients;
back-transforming the differences of the spline coefficients into the time domain and associating the residual values of the spline coefficients with the corresponding measured values of the measured time series.

In this embodiment, the determination of residual values is somewhat more complex. In this embodiment, the time series can be divided into sections with which splines are associated.

A spline, also referred to as a piecewise polynomial, is a mathematical construct used in curve approximation and interpolation. In this process, a curve is approximated by a series of polynomial sections connected so as to form a smooth and continuous curve. Each polynomial section is referred to as a section of the spline and is typically represented by low-order polynomials, for example quadratic or cubic polynomials. Splines are used in order to describe complex shapes and curves. They allow for flexible and efficient representation of curves that can be easily adapted to different requirements. The coefficients of these polynomial sections are referred to as spline coefficients.

The translation of time series into splines can be used in order to limit the data to be monitored or analyzed to a few parameters. This reduces the amount of data to be processed, which is in particular resource-efficient, especially when using machine learning algorithms.

In one embodiment, the relevance values correspond to the standardized residual values.

The relevance values can be the standardized residual values in a particularly straightforward manner. Standardization is important for comparability. It indeed appears that a high residual value initially has particularly high relevance. However, if the residual value is large because the values of the measured time series and the reference time series are also large, then the size at this point is not necessarily meaningful for relevance.

In a standardization, the residual values are set in relation to the values of the time series, preferably the reference time series. This can increase the accuracy of determining the relevance of individual measured values for the subsequent utilization of the measured time series.

In one embodiment, the reference time series is an average time series of a plurality of measured time series.

The reference time series can be determined and provided in various ways. One option is to use historical data and work with average values. For example, a fixed number of measured time series can be temporarily stored, from which an average time series can be formed, which in turn forms the reference time series.

For example, 100 or 1,000 time series can be used for this purpose. The more time series used, the more representative the reference time series becomes. However, as the number of time series increases, so do the memory and computational requirements for determining the reference time series. Particularly in the case of continuous real-time monitoring, computing resources and memory requirements can be a limiting factor when the reference time series is formed from the past x measurements in real time.

In one embodiment, the reference time series was determined using a model of the industrial process.

As an alternative to the use of historical data, synthetic time series can also be used. For example, synthetic time series can be generated by a model by simulating the depicted industrial process and/or calculating the course of the monitored process variable.

The advantage of a synthetic reference time series is that it can be generated in advance and does not tie up additional computing resources during real-time monitoring. Depending on how accurately the model operates, error ranges for the measured values can also be considered when generating the reference time series, so that errors can also be estimated in the residual value calculation.

In one embodiment, the method further comprises:
determining anomalies in the measured time series, wherein the anomalies are one or more measurements having a relevance value above a defined threshold value.

Anomaly detection is a method of data analysis in which certain deviations in an industrial process are automatically detected that do not correspond to the standard or the statistically expected behavior. The goal is to determine through data analysis whether a data point deviates from the normal or intended pattern or behavior. For this purpose, a reference must first exist that defines which behavior can be considered normal.

If the relevance value for a measured value or a series of measured values is particularly high, the measured time series at this point deviates especially strongly from the reference time series. The sensitivity of the anomaly detection can be set using the threshold value. The smaller the threshold value, the more likely deviations are to be captured as an anomaly. If the threshold value is higher, the difference between the measured time series and the reference time series must also be greater in order to detect an anomaly.

In one embodiment, the method further comprises:
providing a further reference time series;
providing a further measured time series, wherein the further measured time series comprises measured values of a further process parameter of the industrial process;
determining residual values for the further measured time series;
determining a relevance value for each measured value of the further measured time series from the residual values; and
determining, from the relevance values of the measured time series, time points of relevance for the industrial process.

When monitoring or analyzing industrial processes, a plurality of process parameters can be captured simultaneously. For example, in a drilling operation, the drill hole depth and pressure on the drill head can be measured. If several parameters are measured, they can be monitored in parallel or evaluated in succession.

When monitoring and/or analyzing a plurality of parameters, a plurality of reference time series must exist, namely at least one for each process parameter, so that the acquired data can be compared to the corresponding reference values.

The relevance values of all measured time series can be summarized into a relevance time series for the entire process, in which each of the monitored parameters provides a portion of the relevance values. The most relevant points in time can be determined from the relevance time series, which indicate the most relevant process steps, in particular those that deviate most strongly from the standard.

In a further aspect, the disclosure relates to a computer-implemented method for training a machine learning system, wherein the training comprises the following steps:
Providing a training dataset, where the training dataset comprises a plurality of measured time series, wherein a relevance value is determined for each measured value of the time series using a method according to description set forth herein;
inputting the training dataset into the machine learning algorithm in order to train the machine learning algorithm; and
providing the trained machine learning algorithm;

The method described above can be used for training a machine learning algorithm in order to prepare the training data. During preprocessing, the measured time series can be combined with the relevance value in order to demonstrate for the machine learning algorithm being trained which parts of the input time series are most relevant for evaluation.

By identifying the most relevant points in time in the industrial process, the training of the machine learning algorithm can be improved so that the trained machine learning algorithm can better perform its task.

Furthermore, the machine learning algorithm can be trained on time series of a plurality of parameters. For each time series of each parameter, individual relevance values are provided, allowing the machine learning algorithm to process the time series independently and adapt to the relevance values.

In one embodiment, the machine learning algorithm comprises a plurality of models, wherein each measured time series comprises at least one range. Each model is associated with one or more ranges and is configured so as to process the measurements of its associated range(s).

The ranges are determined using the following steps:
determining a measured value in the measured time series whose relevance value is a local maximum or exceeds a first defined threshold value,
determining a range around the found measured value in which the relevance value lies above a defined second threshold value.

The causes for the deviations of the measured time curves from their respective reference time series can be diverse. Consequently, it can be advantageous to use different models for monitoring and/or analysis for different process steps.

The measured time series can be divided into ranges based on the relevance values. The data from these ranges can then be input into different models selected according to the task at hand. This can improve the outcome of the monitoring or analysis.

For example, the models can include, but are not limited to: linear models, decision trees, support vector machines, neural networks, and many others.

The ranges to be selected can be adjusted using the first threshold value and the second threshold value. The lower the threshold values, the larger the ranges and vice versa.

In one embodiment, the machine learning algorithm is further trained so as to process range parameters, wherein the range parameters of the at least one range include the start of the range, the end of the range, the mean and/or the median of the measured time series in the range, the standard deviation of the measured time series in the range, the maximum relevance value in the range, the mean relevance value in the range, and/or other values that are characteristic of the range.

The mentioned parameters can be easily determined for each range. The amount of data to be processed by the machine learning algorithm is significantly reduced by selecting range parameters, so that the resources needed for processing can also be reduced. Depending on the model, the model itself can even be simplified.

In one embodiment, each of the measured values is associated with a weight for training the machine learning algorithm, wherein the weight correlates with the relevance of the respective measured value.

In some models, the training data can be weighted so as to reflect the relevance of a respective data point or data packet for the training. Advantageously, the relevance values can be used directly or indirectly as weights.

In a further consideration, the disclosure relates to a computer program having a program code for performing a method as described above when the computer program is executed on a computer.

In a further consideration, the disclosure relates to a computer readable disk having a program code of a computer program for performing a method as described above when the computer program is executed on a computer.

In a further aspect, the disclosure relates to a system for quantifying the relevance of measured values in time series, wherein the system is configured so as to perform a method as described above.

In summary, with the present disclosure, a method for quantifying the relevance of measured values in time series, a method for training an machine learning algorithm, a computer program, a computer readable disk with program code, and a system for quantifying the relevance of measured values in time series is provided.

The described embodiments and further developments can be combined with one another as desired.

Further possible configurations, refinements, and implementations of the disclosure also comprise not explicitly mentioned combinations of features of the disclosure described above or below with respect to exemplary embodiments.

### BRIEF DESCRIPTION OF THE DRAWINGS

The accompanying drawing is intended to provide a better understanding of the embodiments of the disclosure. It illustrates an embodiment and, in connection with the description, serves to explain principles and concepts of the disclosure.

Other embodiments and many of the mentioned advantages become apparent from the drawing. The illustrated elements of the drawing are not necessarily shown to scale with respect to one another.

The FIGURE shows:

FIG. 1 schematically, the process flow of the method according to one embodiment.

In the FIGURE of the drawings, identical reference numbers denote identical or functionally identical elements, parts or components, unless stated otherwise.

### DETAILED DESCRIPTION

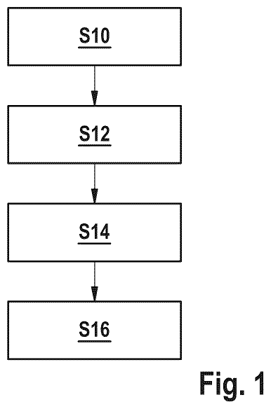

FIG. 1 shows schematically a process flow of the method according to one embodiment.

The method begins in step S10 with the provision of a measured time series. The time series can have been sensed or generated by any sensor or measuring device. Further, the time series can also represent process parameters that are read from an industrial machine. For example, the time series can represent a voltage curve in an electric drive. The time series can therefore be provided by a sensor, measuring device, etc., or can be loaded from a temporary memory of a computing system.

In either case, the time series represents a physical quantity captured in an industrial process. The measured time series can be represented as:
f(t).

In embodiments, a plurality of time series can be provided that each reflect the same physical quantity. This can be the case, in particular, with repeatable industrial processes, in particular with work routines of work machines that are always to be performed the same way. Even in the manufacture of parts with consistent properties, a measured time series can be provided for each part.

In addition to the measured time series, a reference time series is provided in step S12. The reference time series indicates target values for each time point of the industrial process. It serves as a guide for the industrial process in terms of how it should proceed. The reference time series can be represented as:

$${f}_{r e f} ( t ) .$$

When the measured time series depict several process parameters of the same industrial process, for example if they were acquired in parallel or partially in parallel at the same plant, then a reference time series must be provided for each process parameter.

The time series are compared to one another in step S14. In the comparison, residual values are generated that indicate how far the measured time series deviates from the reference time series. Residual value formation can preferably occur in two ways.

A first option is to subtract the measured time series from the reference time series and to use the absolute value of the result as the residual value. The residual values can be described as a function as follows:

$${f}_{r e s} ( t ) = \vert f ( t ) - {f}_{r e f} ( t ) \vert .$$

In a second possibility, the measured time series and the reference time series are approximated by splines. The absolute value of the difference of these spline coefficients generates a new function in the time domain, from which the residual values can be read.

For example, the approximation can be represented by n-th degree spline polynomials as follows:

$${f}_{a p p r o x} ( t ) = \{ \begin{matrix}{f}_{a} ( t ) = {a}_{n} {t}^{n} + {a}_{n - 1} {t}^{n - 1} + … + {a}_{1} t + {a}_{0} f \ddot{u} r 0 < t \leq {t}_{a} \\ {f}_{b} ( t ) = {b}_{n} {t}^{n} + {b}_{n - 1} {t}^{n - 1} + … + {b}_{1} t + {b}_{0} f \ddot{u} r {t}_{a} < t \leq {t}_{b} \\ ⋮ \\ {f}_{x} ( t ) = {x}_{n} {t}^{n} + {x}_{n - 1} {t}^{n - 1} + … + {x}_{1} t + {x}_{0} f \ddot{u} r {t}_{x - 1} < t\end{matrix} .$$

For example, for the residual values, it can then result in:

$${f}_{res} ( t ) = \{ \begin{matrix}{f}_{res , a} ( t ) f \ddot{u} r 0 < t \leq {t}_{a} \\ {f}_{res , b} ( t ) f \ddot{u} r {t}_{a} < t \leq {t}_{b} \\ ⋮ \\ {f}_{res , x} ( t ) f \ddot{u} r {t}_{x - 1} < t\end{matrix}$$

$$where :$$

$${f}_{res , a} ( t ) = \vert {a}_{n} - {a}_{res , n} \vert {t}^{n} + \vert {a}_{n - 1} - {a}_{res , n - 1} \vert {t}^{n - 1} + … + \vert {a}_{1} - {a}_{res , 1} \vert t + \vert {a}_{0} - {a}_{res , 0} \vert f \ddot{u} r 0 < t \leq {t}_{a}$$

$${f}_{res , b} ( t ) = \vert {b}_{n} - {b}_{res , n} \vert {t}^{n} + \vert {b}_{n - 1} - {b}_{res , n - 1} \vert {t}^{n - 1} + … + \vert {b}_{1} - {b}_{res , 1} \vert t + \vert {b}_{0} - {b}_{res , 0} \vert f \ddot{u} r {t}_{a} < t \leq {t}_{b}$$

$$⋮$$

$${f}_{res , x} ( t ) = \vert {x}_{n} - {x}_{res , n} \vert {t}^{n} + \vert {x}_{n - 1} - {x}_{res , n - 1} \vert {t}^{n - 1} + … + \vert {x}_{1} - {x}_{res , 1} \vert t + \vert {x}_{0} - {x}_{res , 0} \vert f \ddot{u} r {t}_{x - 1} < t$$

In the last step S16, a relevance value is determined for each measured value from the residual value assigned thereto. Preferably, the relevance value can be determined by standardizing the residual value. The standardization advantageously causes the relevance values of different time series, including those of different dimensions, to be comparable with one another. For example, the relevance of measuring a temperature can be compared to the relevance of measuring a force.

For example, the relevance values can be calculated as follows:

$${f}_{r e l} ( t ) = \frac{{f}_{r e s} ( t )}{{f}_{r e f} ( t ) * Max ( \frac{f r e s ( t )}{{f}_{r e f} ( t )} )} .$$

What is claimed is:

1. A computer-implemented method for quantifying relevance of measured values in time series, comprising:
providing a measured time series, wherein the measured time series comprises a temporally ordered sequence of measured values, wherein the measured values have been captured as process parameters of an industrial process;
providing a reference time series;
determining residual values for the measured time series by comparing the measured time series to the reference time series; and
determining a relevance value for each measured value of the measured time series from the residual values.

2. The computer-implemented method according to claim 1, wherein the residual values are determined from the difference between the measured time series and the reference time series.

3. The computer-implemented method according to claim 1, wherein the determination of the residual values comprises:
determining spline coefficients for the reference time series;
determining the spline coefficients for the measured time series;
determining the difference or differences between the spline coefficients of the reference time series and the measured time series, wherein the residual values are determined from the difference or differences of the spline coefficients; and
back-transforming the differences of the spline coefficients into the time domain and associating the residual values of the spline coefficients with the corresponding measured values of the measured time series.

4. The computer-implemented method according to claim 1, wherein the relevance values correspond to the standardized residual values.

5. The computer-implemented method according to claim 1, wherein the reference time series is an averaged time series from a plurality of measured time series or wherein the reference time series has been determined with a model of the industrial process.

6. The computer-implemented method according to claim 1, wherein the method further comprises:
determining anomalies in the measured time series, wherein the anomalies are one or more measurements having a relevance value above a defined threshold value.

7. The computer-implemented method according to claim 1, wherein the method further comprises:
providing a further reference time series;
providing a further measured time series, wherein the further measured time series comprises measured values of a further process parameter of the industrial process;
determining residual values for the further measured time series;
determining a relevance value for each measured value of the further measured time series from the residual values; and
determining, from the relevance values of the measured time series, time points of relevance for the industrial process.

8. A computer-implemented method for training a machine learning algorithm, comprising:
providing a training dataset, wherein the training dataset comprises a plurality of measured time series, and wherein a relevance value is determined for each measured value of the time series using a method according to claim 1;
inputting the training dataset into the machine learning algorithm in order to train the machine learning algorithm; and
providing the trained machine learning algorithm.

9. The computer-implemented method according to claim 8, wherein:
the machine learning algorithm comprises a plurality of models,
each of the measured time series comprises at least one range,
each model is associated with one or more ranges and is configured so as to process the measured values of the range or ranges associated with it, and
the ranges are determined using the following steps (i) determining a measured value in the measured time series whose relevance value is a local maximum or exceeds a first defined threshold value, and (ii) determining a range around the found measured value in which the relevance value lies above a defined second threshold value.

10. The computer-implemented method according to claim 8, wherein:
the machine learning algorithm is further trained so as to process range parameters, and
the range parameters of the at least one range include the start of the range, the end of the range, the mean and/or the median of the measured time series in the range, the standard deviation of the measured time series in the range, the maximum relevance value in the range, the mean relevance value in the range, and/or other values that are characteristic of the range.

11. The computer-implemented method according to claim 8, wherein:
each of the measured values is associated with a weight for training the machine learning algorithm, and
the weight correlates with the relevance of the respective measured value.

12. A computer program having a program code to execute a method according to claim 1, when the computer program is executed on a computer.

13. A computer-readable data carrier having a program code of a computer program to execute a method according to claim 1, when the computer program is executed on a computer.

14. A system for quantifying relevance of measured values in time series, wherein the system is configured so as to carry out a method according to claim 1.
